(19) United States
(12) Patent Application Publication
(10) Pub. No.: US 2012/0182476 A1
(43) Pub. Date: Jul. 19, 2012

(54) SYSTEM AND METHOD FOR DISPLAYING SCREEN MENU ADJUSTMENT

(75) Inventor: TENG-YU TSAI, Tu-Cheng (TW)

(73) Assignee: HON HAI PRECISION INDUSTRY CO., LTD., Tu-Cheng (TW)

(21) Appl. No.: 13/311,921

(22) Filed: Dec. 6, 2011

(30) Foreign Application Priority Data
Jan. 14, 2011 (TW) 100101325

(51) Int. Cl. H04N 5/445

(52) U.S. Cl. 348/563; 348/E05.105

(57) ABSTRACT

A system for displaying information of the menu adjustment on a monitor is disclosed. A remote control is adapted to emit a first control signal. A TV card comprises a receiving module and a transmitting module, the receiving module being adapted to receive the first control and send the first control signal to the transmitting module, and the transmitting module being adapted to transmit a second control signal corresponding to the first control signal. A host is connected to the TV card and comprises a storage module adapted to store a database storing a plurality of information of the menu adjustment to be displayed on the monitor.

### BACKGROUND

1. Technical Field

The disclosure generally relates to a system and a method for displaying a menu adjustment.

2. Description of Related Art

A computer can be used as a television (TV) with typical operations such as changing programs or adjusting the brightness or volume. A user interface (UI) is an on screen menu adjustment corresponding to each operation is displayed in a screen of the computer. However, contents of the on screen menu adjustment are so monotonous which can cause visual fatigue. Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block view showing components and a connection relationship of a display system of an embodiment.

FIG. 2 is a flow chart of an embodiment of a display method on a monitor.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

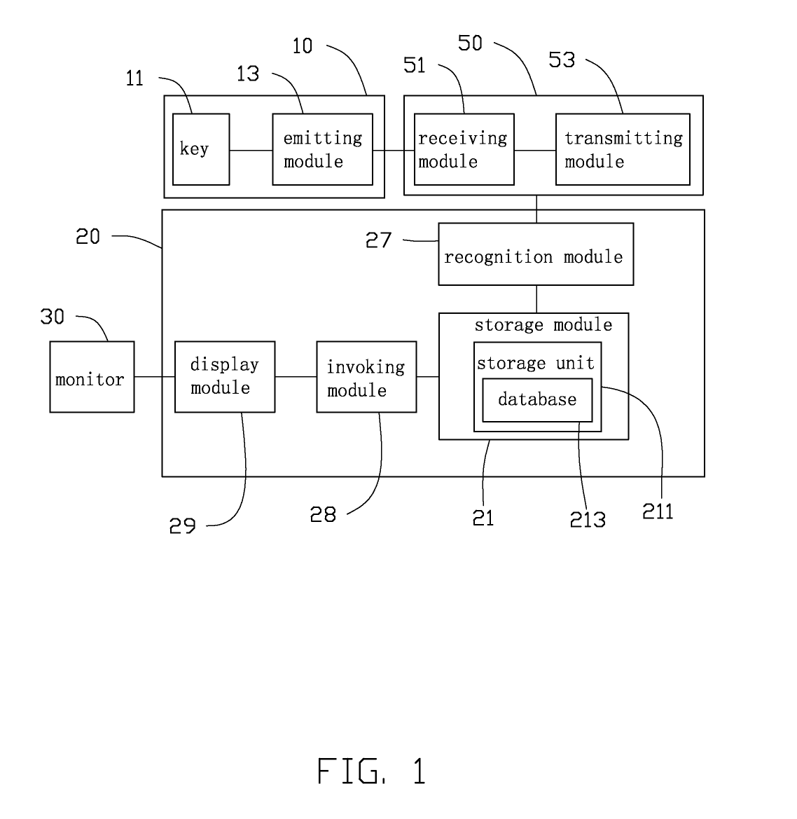

Referring to FIG. 1, a display system includes a remote control 10, a host 20, a monitor 30, and a television (TV) card 50.

The remote control 10 includes a plurality of keys 11 and an emitting module 13. The keys 11 start a first control signal of an on screen menu adjustment. In one embodiment, one of the keys 11 is a TV remote control channel up/down module or a volume up/down module capable of performing the on screen menu adjustment. The emitting module 13 emits the first control signal of the on screen menu adjustment to the TV card 50. In one embodiment, the first control signal is an analog signal.

The TV card 50 is connected to the host 20 and includes a receiving module 51 and a transmitting module 53. The receiving module 51 receives the first control signal emitted from the emitting module 13 and sends the first control signal to the transmitting module 53.

The host 20 comprises a storage module 21, a recognition module 27, an invoking module 28, and a display module 29.

The storage module 21 comprises a plurality of storage units 211 and a database 213. Each storage unit 211 corresponds to a fixed storage location. The storage location corresponds to a plurality of pixels of the monitor 30. The database 213 can be stored in the storage unit 211 by an XML method. The database 213 includes a plurality of menu modules such as the TV remote control channel up/down module or the volume up/down module. Each menu module includes a plurality of menu adjustments. Each menu adjustment includes information, such as pictures, animation, and characters. For example, one menu adjustment in the database 213 for the volume up/down module can be a monkey climbing up/down on a ladder or a lift going up/down from a lower/upper floor. An user can choose one menu adjustment according to preference.

The transmitting module 53 receives the first control signal and transmits a second control signal corresponding to the first control signal to the recognition module 27. The second control signal is a digital signal identifiable by the recognition module 27. The second control signal includes a searching order and the storage location corresponding to the storage unit 211.

The recognition module 27 recognize s the search order in the second control signal and searches the menu adjustment corresponding to the storage location according to the second control signal.

The invoking module 28 invokes and starts the display module 29, and sends the information of the menu adjustment and the pixels corresponding to the storage location to the display module 29.

The display module 29 drives the monitor 30 to display the information of the menu adjustment in the location of corresponding pixels of the monitor 30.

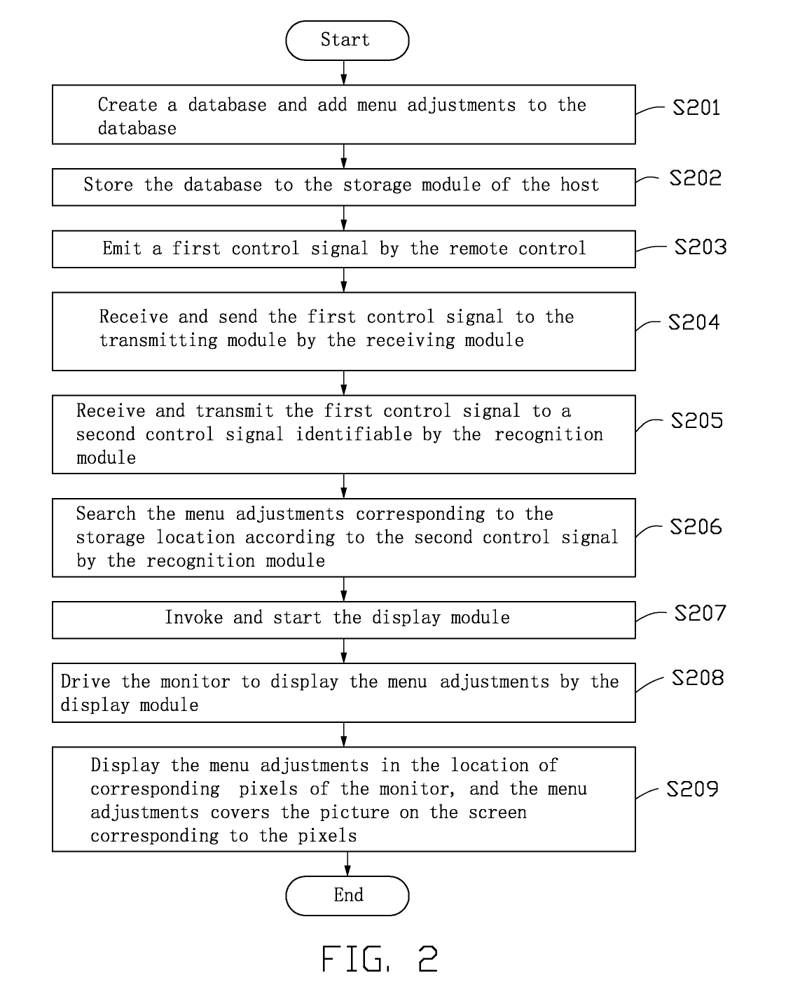

FIG. 2 is an operational flow diagram representing one embodiment of a screen display method. The method may include the following steps.

In step S201, the database 213 is created and the menu adjustments are added to the database 213.

In step S202, the database 213 is stored in the storage module 21 of the host 20.

In step S203, the emitting module 13 of the remote control 10 emits a first control signal

In step S204, the receiving module 51 receives and sends the first control signal to the transmitting module 53.

In step S205, the transmitting module 53 receives the first control signal and transmits a second control signal corresponding to the first control signal to the recognition module 27.

In step S206, the recognition module 27 recognize the search order in the second control signal and searches the menu adjustment corresponding to the storage location according to the second control signal.

In step S207, the invoking module 28 invokes and starts the display module 29, and sends the information of the menu adjustment and the pixels corresponding to the storage location to the display module 29.

In step S208, the display module 29 drives the monitor 30 to display the menu adjustment.

In step S209, the monitor 30 displays the menu adjustment in the location of corresponding pixels of the monitor. The information of the menu adjustment can be a picture on the monitor.

The screen display method further includes a step deleting or adding or changing the information of the menu adjustment within the database.

It is to be understood, however, that even though numerous characteristics and advantages have been set forth in the foregoing description of embodiments, together with details of the structures and functions of the embodiments, the disclosure is illustrative only and changes may be made in detail, especially in matters of shape, size, and arrangement of parts within the principles of the disclosure to the full extent indicated by the broad general meaning of the terms in which the appended claims are expressed.

Depending on the embodiment, certain steps or methods described may be removed, others may be added, and the sequence of steps may be altered. It is also to be understood that the description and the claims drawn for or in relation to a method may include some indication in reference to certain steps. However, any indication used is only to be viewed for identification purposes and not as a suggestion as to an order for the steps.

What is claimed is:

1. A display method for displaying information on a monitor, the method comprising:
providing the monitor, a remote control for the monitor, a TV card, and a host, the TV card comprising a receiving module and a transmitting module, the host comprising a recognition module, a storage module, a display module, and an invoking module;
creating a database, the database comprising a plurality of menu modules, the menu modules comprising a plurality of menu adjustments, the menu adjustments comprising the information;
emitting a first control signal from the remote control;
receiving the first control signal by the receiving module and sending the first control signal to the transmitting module;
transmitting a second control signal corresponding to the first control signal by the transmitting module;
recognizing the second control signal and searching information of the menu subject according to the second control signal by the recognition module;
invoking the display module and sending the information of the menu adjustment to the display module by the invoking module; and
displaying the information of the menu adjustment on the monitor by the display module.

2. The method of claim 1, wherein the storage module comprises a plurality of storage units, the database is stored in the storage units, and the information of the menu adjustment is stored in the database.

3. The method of claim 2, further comprising deleting or adding or changing the information of the menu adjustment within the database.

4. The method of claim 1, further comprising choosing one menu adjustment and displaying the one menu adjustment on a screen of the monitor.

5. The method of claim 4, wherein the information of menu adjustment comprises pictures, animations, and characters.

6. A system for displaying information of a menu adjustment on a monitor, the system comprising:
a remote control adapted to emit a first control signal;
a TV card comprising a receiving module and a transmitting module, the receiving module adapted to receive the first control signal and send the first control signal to the transmitting module, and the transmitting module adapted to transmit a second control signal corresponding to the first control signal; and
a host connected to the TV card and comprising a storage module adapted to store a database storing a plurality of information of the menu adjustment, the host is adapted to receive the second control signal and send the second control signal to the monitor, and the monitor is adapted to display the information of the menu adjustment on a screen of the monitor according to the second control signal.

7. The system of claim 6, wherein the first control signal is an analog signal, and the second control signal is a digital control signal.

8. The system of claim 6, wherein the storage module comprises a plurality of storage units, each of the storage units corresponds to a fixed storage location, and the storage location corresponds to a plurality of pixels of the screen; the information of the menu adjustment comprises pictures, animations, and characters.

9. The system of claim 8, wherein the database is stored in the storage unit by a XML method.

10. The system of claim 8, wherein the second control signal comprises a searching order and the storage location corresponding to the menu adjustment.

11. The system of claim 10, wherein the host further comprises a recognition module, an invoking module, and a display module, the recognition module is adapted to search the storage locations according to the searching order, and the recognition module is further configured to find the menu adjustment corresponding to a recognized storage location.

12. The system of claim 11, wherein the invoking module is adapted to invoke the display module to display the menu adjustment on the screen.

13. A system for displaying information of a menu adjustment on a monitor, the system comprising:
a remote control adapted to emit a first control signal;
a TV card comprising a receiving module and a transmitting module, the receiving module adapted to receive the first control signal and send the first control signal to the transmitting module, and the transmitting module adapted to transmit a second control signal corresponding to the first control signal; and
a host connected to the TV card and comprising a storage module adapted to store a database storing a plurality of information of the menu adjustment, a recognition module adapted to search the information of the menu adjustment according to the second control signal, and an invoking module and a display module, wherein the invoking module is adapted to invoke the display module to display the information of the menu adjustment on a screen of the monitor.

14. The system of claim 13, wherein the first control signal is an analog signal, and the second control signal is a digital control signal.

15. The system of claim 13, wherein the storage module comprises a plurality of storage units, each of the storage units corresponds to a fixed storage location, and the storage location corresponds to a plurality of pixels of the screen; the information of the menu adjustment comprises pictures, animations, and characters.

16. The system of claim 15, wherein the database is stored in the storage unit by a XML method.

17. The system of claim 15, wherein the second control signal comprises a searching order and the storage location corresponding to the menu adjustment.

18. The system of claim 17, wherein the recognition module searches the storage location according to the searching order, and finds the menu adjustment corresponding to the storage location.
